(19) United States
(12) Patent Application Publication
(10) Pub. No.: US 2004/0246989 A1
(43) Pub. Date: Dec. 9, 2004

(54) SONET over PON

(76) Inventor: Steve Brolin, Livingston, NJ (US)

Correspondence Address: SWIDLER BERLIN SHEREFF FRIEDMAN, LLP, 3000 K STREET, NW, BOX IP, WASHINGTON, DC, 20007, US

(21) Appl. No.: 10/452,136

(22) Filed: Jun. 3, 2003

(51) Int. Cl. H04L 12/56

(52) U.S. Cl. 370/466; 370/352; 370/400

(57) ABSTRACT

A system provides the capability to transmit SONET over PON, which simplifies the necessary conversions and provide improved functionality over existing techniques. The system for interfacing a Synchronous Optical Network to a Passive Optical Network comprises an Optical Line Termination unit operable to interface with the Synchronous Optical Network and with the Passive Optical Network, receive a downstream data signal from the Synchronous Optical Network and transmit the downstream data signal in SONET format over the Passive Optical Network, and receive an upstream data signal from the Passive Optical Network in a PON encapsulated SONET format and transmit the upstream data signal over the Synchronous Optical Network; and at least one Optical Network Unit operable to interface with the Passive Optical Network and with at least one end user, receive a downstream data signal from the Passive Optical Network and transmit the downstream data signal to the at least one end user, and receive an upstream data signal from the at least one end user and transmit the upstream data signal over the Passive Optical Network.

### FIELD OF THE INVENTION

The present invention relates to a system that provides the capability to transmit SONET over PON.

### BACKGROUND OF THE INVENTION

Optical networks have become a standard technology for the transport of information in the telecommunications industry. A number of different optical network standards have been defined, with each having advantages and disadvantages for different uses. Synchronous optical network (SONET) is one standard for optical telecommunications transport. SONET is expected to provide the transport infrastructure for worldwide telecommunications for at least the next two or three decades. The increased configuration flexibility and bandwidth availability of SONET provides significant advantages over the older telecommunications system, such as reduction in equipment requirements, increase in network reliability, ability to carry signals in a variety of formats, a set of generic standards that enable products from different vendors to be connected, and a flexible architecture capable of accommodating future applications, with a variety of transmission rates. SONET is often used for long-haul, metro level, and access transport applications.

Another standard for optical telecommunications transport is passive optical networks (PONs). PONs are commonly used to address the last mile of the communications infrastructure between the service provider's central office, head end, or point of presence (POP) and business or residential customer locations. Also known as the access network or local loop, the last mile consists predominantly, in residential areas, of copper telephone wires or coaxial cable television (CATV) cables. In metropolitan areas, where there is a high concentration of business customers, the access network often includes high-capacity synchronous optical network (SONET) rings, optical T3 lines, and copper-based T1s.

Bandwidth is increasing dramatically on long-haul networks through the use of wavelength division multiplexing (WDM) and other new technologies. Recently, WDM technology has even begun to penetrate metropolitan-area networks (MAN), boosting their capacity dramatically. At the same time, enterprise local-area networks (LAN) have moved from 10 Mbps to 100 Mbps, and soon many LANs will be upgraded to gigabit Ethernet speeds. The result is a growing gulf between the capacity of metro networks on one side and end-user needs on the other, with the last-mile bottleneck in between.

PONs are one solution to this problem in an attempt to break the last-mile bandwidth bottleneck that other access network technologies do not adequately and economically address. The two conventional types of PON technology are asynchronous transfer mode PONs (APONs) and Ethernet PONs (EPONs). Interest in APONs is waning due to high cost, and fewer opportunities for network connection-without format conversion (out of ATM). EPONs provide a good solution for Ethernet connectivity, but are of limited usefulness for other types of connectivity. Even when applied to Ethernet transport, EPONs need to utilize frame fragmentation or accept inefficient use of bandwidth due to highly variable frame lengths, coupled with usually fixed timeslot allocations.

In particular, problems arise with both APON and EPON when interfaced to a SONET transport architecture. Considerable conversion must be performed to provide the interface and even then, functionality may be limited or problematic. A need arises for a technique by which SONET may be transmitted over PON, which would simplify the necessary conversions and provide improved functionality over existing techniques.

### SUMMARY OF THE INVENTION

The present invention is a system that provides the capability to transmit SONET over PON, which simplifies the necessary conversions and provide improved functionality over existing techniques.

In one embodiment of the present invention, a system for interfacing a Synchronous Optical Network/Synchronous Digital Hierarchy to a Passive Optical Network, the system comprises an Optical Line Termination unit operable to interface with the Synchronous Optical Network/Synchronous Digital Hierarchy and with the Passive Optical Network, receive a downstream data signal from the Synchronous Optical Network/Synchronous Digital Hierarchy and transmit the downstream data signal over the Passive Optical Network, as a Synchronous Optical Network/Synchronous Digital Hierarchy data signal, and receive an upstream Synchronous Optical Network/Synchronous Digital Hierarchy data signal from the Passive Optical Network and transmit the upstream data signal over the Synchronous Optical Network/Synchronous Digital Hierarchy; and at least one Optical Network Unit operable to interface with the Passive Optical Network and with at least one end user, receive a downstream data signal from the Passive Optical Network and transmit the downstream data signal to at least one end user, and receive an upstream data signal from the at least one end user and transmit the upstream data signal over the Passive Optical Network.

In one aspect of the present invention, at least one Optical Network Unit is further operable to receive a downstream data signal from the Passive Optical Network, as a Synchronous Optical Network/Synchronous Digital Hierarchy data signal including Synchronous Optical Network/Synchronous Digital Hierarchy encapsulation, remove the Synchronous Optical Network/Synchronous Digital Hierarchy encapsulation, and transmit the decapsulated downstream data signal to the at least one end user, and receive an upstream data signal from the at least one end user, encapsulate the upstream data signal in Synchronous Optical Network/Synchronous Digital Hierarchy encapsulation, and transmit the encapsulated upstream data signal over the Passive Optical Network. The desired end user format may comprise at least one of: Ethernet, Internet Protocol multicast, Plain Old Telephone Service, T1, T3, or native Synchronous Optical Network format, such as EC1.

In one aspect of the present invention, the upstream data signal received from the end user comprises a Synchronous Optical Network Synchronous Payload Envelope. The Optical Network Unit may be further operable to convert the upstream data signal received from the end user to the optical format by adding a Passive Optical Network Layer to the Synchronous Optical Network Synchronous Payload Envelope. The Optical Line Termination may be further operable to strip the Passive Optical Network Layer from the upstream data signal received from Optical Network Unit and preserve the Synchronous Optical Network Synchronous Payload Envelope. Alternatively, the upstream data signal from the end user may be a native format, such as Ethernet, T1, T3, etc., or a combination of these.

In one aspect of the present invention, there is a plurality of Optical Network Units. The downstream data signal received from the Optical Line Terminations over the Passive Optical Network may comprise a plurality of Optical Network Units specific signals. The system may further comprise a splitter/combiner operable to divide the downstream data signal comprising the plurality of Optical Network Units specific signals into a plurality of downstream data signals, each downstream data signal on one of a plurality of optical fibers, comprising the plurality of Optical Network Units specific signals. Each Optical Network Unit may be further operable to accept an Optical Network Unit specific signal intended for that Optical Network Unit and discard the Optical Network Unit specific signals not intended for that Optical Network Unit.

In one aspect of the present invention, each of the Optical Network Unit transmits Optical Network Unit specific upstream data signal over the Passive Optical Network. The system may further comprise a splitter/combiner operable to combine the Optical Network Unit specific upstream data signals to form a combined upstream data signal comprising the Optical Network Unit specific upstream data signals. The Optical Network Unit specific upstream data signals may be combined using Time Division Multiplexing, the Time Division Multiplexing controlled by the Optical Network Unit using information from the Optical Line Termination, and the combining performed by passively combining optical signals carrying the upstream data signals. The combined upstream data signal may comprise Optical Network Unit specific upstream data signals separated from other Optical Network Unit specific upstream data signals by guardbands. Each Optical Network Unit specific upstream data signal in the combined upstream data signal may comprise at least one Time Division Multiplexing time slot. Each guardband in the combined upstream data signal may comprise at least one Time Division Multiplexing time slot. Each Optical Network Unit may comprise a plurality of data buffers, each data buffer operable to receive an upstream data signal from an end user after Synchronous Optical Network/Synchronous Digital Hierarchy encapsulation and to transmit the received upstream data signal to the Optical Line Termination over the Passive Optical Network. Each data buffer may be operable to receive an upstream data signal from an end user while another data buffer is transmitting a received upstream data signal to the Optical Line Termination over the Passive Optical Network. Likewise, each data buffer may be operable to transmit a received upstream data signal to the Optical Line Termination over the Passive Optical Network while another data buffer is receiving an upstream data signal from an end user. Each Optical Network Unit may be further operable to perform ranging, using information from an Optical Line Termination, to compensate for differing distances between the Optical Line Termination and each Optical Network Unit.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary block diagram of a SONET over PON system, according to the present invention.

FIG. 2 is an exemplary block diagram of one embodiment a SONET over PON system, according to the present invention.

FIG. 3 is an exemplary data flow diagram of downstream transmission of data in the SONET over PON system of the present invention.

FIG. 4 is an exemplary data flow diagram of upstream transmission of data in the SONET over PON system of the present invention.

FIG. 5 is an exemplary format of a combined upstream signal.

FIG. 6 is an exemplary illustration of SONET PON upstream delay.

FIG. 7 is an exemplary block diagram of one embodiment a SONET over PON system, according to the present invention, which provides simultaneous protection and working signals.

### DETAILED DESCRIPTION OF THE INVENTION

The present invention provides the capability for Synchronous Optical Network (SONET) transmission over Passive Optical Network (PON), which allows all native format (DS1, DS3, Ethernet, etc) conversions to SONET to be made close to service origination in Optical Network Unit (ONU) and then transmitted as standard SONET format through the existing and growing SONET network in Access, Metropolitan, and Core networks.

Synchronous Optical Network (SONET) is a standard for connecting fiber-optic transmission systems. SONET was proposed by Bellcore in the middle 1980s and is now an ANSI standard. SONET defines interface standards at the physical layer of the OSI seven-layer model. The standard defines a hierarchy of interface rates that allow data streams at different rates to be multiplexed. SONET establishes Optical Carrier (OC) levels from 51.8 Mbps (about the same as a T-3 line) to 2.48 Gbps. With the implementation of SONET, communication carriers throughout the world can interconnect their existing digital carrier and fiber optic systems.

Synchronous Digital Hierarchy (SDH) is the international equivalent of SONET and was standardized by the International Telecommunications Union (ITU). SDH is an international standard for synchronous data transmission over fiber optic cables. SDH defines a standard rate of transmission at 155.52 Mbps, which is referred to as STS-3 at the electrical level and STM-1 for SDH. STM-1 is equivalent to SONET's Optical Carrier (OC) levels −3.

In this document, a number of embodiments of the present invention are described as incorporating SONET. Although, for convenience, only SONET embodiments are explicitly described, one of skill in the art would recognize that all such embodiments may incorporate SDH and would understand how to incorporate SDH in such embodiments. Therefore, wherever SONET is used in this document, the use of either SONET or SDH is intended and the present invention is to be understood to encompass both SONET and SDH.

PON architectures are point to multi-point. Downstream from Optical Line Termination (OLT) to ONUs conventional SONET format may readily be used, preferably with some modifications, such as use of new functions for normally unused line/section overhead bytes. Upstream, however, significant adaptations to SONET are made in accordance with the present invention. Thus, the present invention provides the capability for the SONET data and path overhead to be transmitted upstream by multiple ONUs, while avoiding collisions through standard PON techniques of ranging and guardbands. The OLT then strips off the PON layer, while preserving the SONET Synchronous Payload Envelope (SPE) consisting of SONET encapsulated end-customer data and path overhead (which travels with the data till the ultimate terminating of the data path).

The OLT is a SONET multiplexer and switch, which isn't burdened by the complexity of multiple different types of services that the various ONU types need to deal with, as is typical for SONET. The OLT then interfaces with the transport network in standard SONET format, with the PON physical layer stripped off and replaced with standard SONET line/section layers.

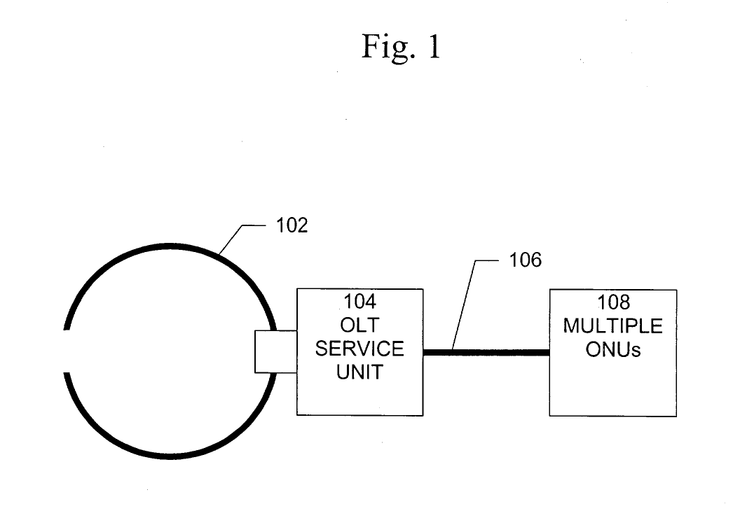

An exemplary SONET over PON system, according to the present invention, is shown in FIG. 1. A SONET network 102 is connected to an Optical Line Termination Service Unit (OLT SU) 104, which provides the interface with the working and protection sides of SONET network 102. OLT SU 104 is also connected to a Passive Optical Network (PON) 106, which is connected to multiple Optical Network Units (ONUs) 108. The ONU provides the interface between the customer's data, video, and telephony networks and the PON. The primary function of the ONU is to receive traffic in an optical SONET/SDH format and convert it to the end user's desired format (Ethernet, IP multicast, POTS, T1, etc.) and to receive traffic from the end user and convert it to an optical SONET/SDH format. Alternatively, the end user's format could also be in a SONET format, such as EC1.

The passive elements of PON 106 are located in the optical distribution network and may include single-mode fiber-optic cable, passive optical splitters/couplers, connectors, and splices. Active network elements, such as OLT 104 and multiple ONUs 108, are located at the end points of PON 106. Optical signals traveling across the PON are either split onto multiple fibers or combined onto a single fiber by optical splitters/couplers, depending on whether the light is traveling up or down the PON. The PON is typically deployed in a single-fiber, point-to-multipoint, tree-and-branch configuration for residential applications. The PON may also be deployed in a protected ring architecture for business applications or in a bus architecture for campus environments and multiple-tenant units (MTU).

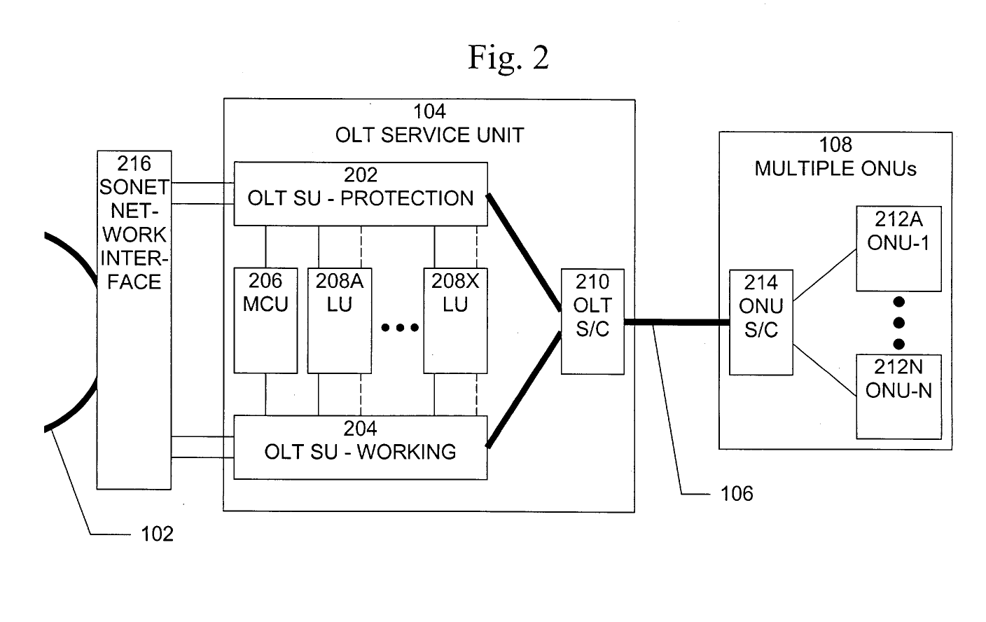

An exemplary SONET over PON system, shown in FIG. 1, is shown in more detail in FIG. 2. As shown in FIG. 2, OLT SU 104 includes OLT SU-Protection 202, OLT SU—Working 204, Management & Control Unit (MCU) 206, a plurality of Line Units (LUs) 208A-X and OLT splitter/combiner 210. Multiple ONUs 108 include a plurality of ONUs 212A-N and ONU splitter combiner 214. Also shown is SONET network interface 216, which provides the interface between OLT SU 104 and SONET network 102.

Each ONU 212A-N provides an interface between the customer's data, video, and telephony networks and PON 106. The primary function of the ONU is to receive traffic in an optical SONET/SDH format and convert it to the customer's desired format (Ethernet, IP multicast, POTS, T1, etc.). ONU splitter/combiner 214 splits the downstream signal from OLT SU 104 among the multiple ONUs 212A-N and combines the upstream ONU-specific signals from each ONU 212A-N to form a combined upstream signal, which is then transmitted over PON 106.

OLT SU 104 provides the interface with the working and protection sides of SONET network 102. In particular, OLT SU—Protection 202 provides the interface with the protection side of SONET network 102 and OLT SU—Working 204 provides the interface with the working side of SONET network 102. MCU 206 provides management functions to OLT SU 104 and the associated ONUs 108, via interfacing with local craft ports, SONET Digital Control Channel (DCC), and/or others. The provided functions include, for example, downloading configuration settings, collection of SONET Performance Monitoring counts, alarms and outages, and controlling protection switching. Each LU 208A-X provides timing control to access precision network clock, provides SONET frame pulse reference, and can contain optical interfaces to transmit part of all of the SONET data on the PON network to the SONET network, to supplement data fed directly to the SONET network by the OLT.

OLT splitter/combiner 210 splits the combined upstream signal, which is received from PON 106, into two signals that are input to both OLT SU—Protection 202 and OLT SU—Working 204. This provides the working and protection signals that are transmitted over SONET 102. Since the PON implementation shown in FIG. 2 does not support simultaneous protection and working signals, the downstream output of OLT SU—Protection 202 and OLT SU—Working 204 cannot both be on simultaneously. In normal operation, the downstream output of OLT SU—Working 204 is on and the downstream output OLT SU—Protection 202 is off. However, should the working circuit of SONET 102 fail, the downstream output of OLT SU—Working 204 can be turned off and the downstream output OLT SU—Protection 202 can be turned on. OLT splitter/combiner 210 provides the capability to couple whichever output is on onto PON 106. The protection level of this implementation is known as 1:1 protection, as it only protects against failure of an OLT, not against failure of the PON fiber.

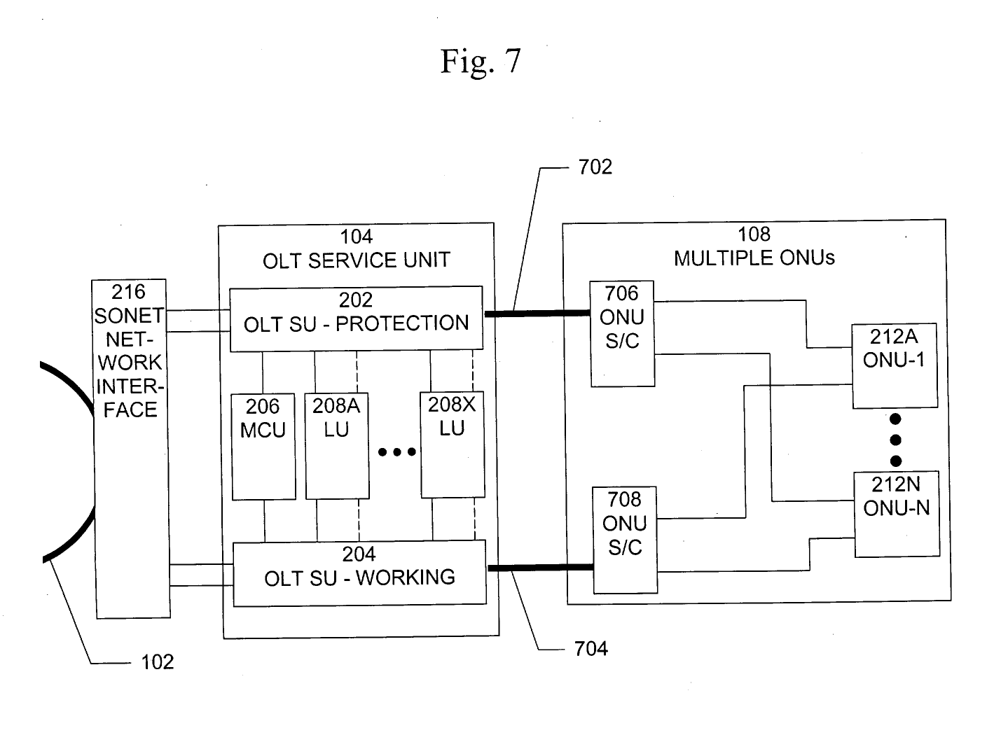

Turning briefly to FIG. 7, an alternate PON implementation that provides simultaneous protection and working signals is shown. In the embodiment shown in FIG. 7, each OLT is connected through a separate PON fiber to multiple ONUs 108. For example, OLT SU—Protection 202 is connected through PON fiber 702 to multiple ONUs 108, while OLT SU—Working 204 is connected through PON fiber 704 to multiple ONUs 108. PON fiber 702 is connected to ONU splitter/combiner 706, which splits the downstream signal from OLT SU—Protection 202 among the multiple ONUs 212A-N and combines the upstream ONU-specific signals from each ONU 212A-N to form a combined upstream signal, which is then transmitted over PON fiber 702. PON fiber 704 is connected to ONU splitter/combiner 708, which splits the downstream signal from OLT SU—Protection 204 among the multiple ONUs 212A-N and combines the upstream ONU-specific signals from each ONU 212A-N to form a combined upstream signal, which is then transmitted over PON fiber 704. Each ONU 212A-N is connected to two signals, one from ONU splitter/combiner 706 and one from ONU splitter/combiner 708. The protection level of this implementation is known as 1+1 protection, as it not only protects against failure of an OLT, but also protects against failure of a PON fiber and against failures due to ONU optics failure.

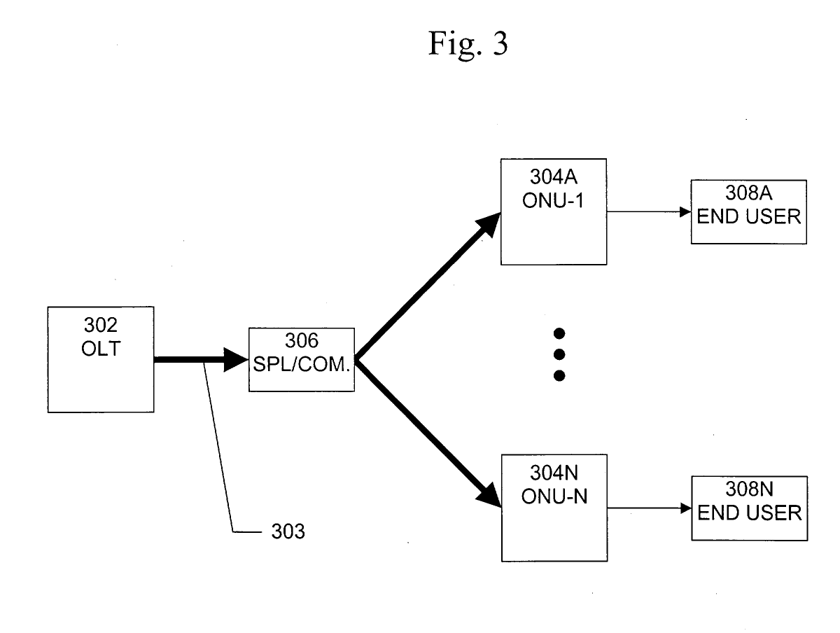

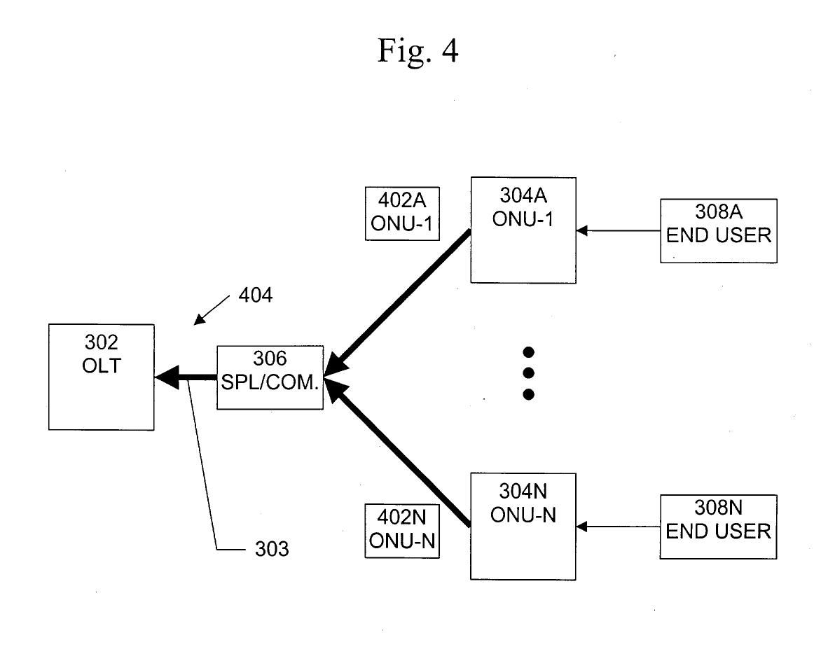

The process of transmitting data downstream from the OLT to multiple ONUs is fundamentally different from transmitting data upstream from multiple ONUs to the OLT. The different techniques used to accomplish downstream and upstream transmission are illustrated in FIGS. 3 and 4. FIG. 3 illustrates typical downstream transmission of data in the SONET over PON system of the present invention. OLT 302 is connected via PON 303 to multiple ONUs 304A-N via splitter/combiner 306. Each ONU is connected and supplies data to one or more end users 308A-N. In FIG. 3, data is broadcast downstream in SONET format, from OLT 302 to multiple ONUs 304A-N. In SONET format, SONET channels are interspersed with other SONET channels over a SONET frame. SONET channels may include one or more formats, such as STS-1, VT1.5, STS-3C, etc. Each SONET channel is intended for a particular ONU-1 304A through ONU-N 304N. Each SONET channel carries a header. The intended ONU is identified by an overhead byte, the SONET channel itself, or both. In addition, data in some SONET channels may be intended for all of the ONUs 304A-N (broadcast packets) or a particular group of ONUs (multicast packets). Splitter/combiner 306 divides the traffic into N separate signals, each carrying all of the ONU-specific SONET channels. When the data reaches an ONU, such as ONU-1 304A, ONU-1 304A accepts the SONET channels that are intended for it and discards the SONET channels that are intended for other ONUs. For example, in FIG. 3, ONU-1 304A receives all SONET channels. However, ONU-1 304A delivers only the data carried in the SONET channel intended for ONU-1 304A to end user 308A. Typically, the ONU will strip off the SONET layer and recover the encapsulated signal in native format for delivery to the end user.

FIG. 4 illustrates typical upstream transmission of data in the SONET over PON system of the present invention. OLT 302 is connected via PON 303 to multiple ONUs 304A-N via splitter/combiner 306. Each ONU is connected to and receives data from one or more end users 308A-N. In FIG. 4, data signals are sent upstream in signals carrying SONET channel timeslots from each ONU. Each SONET channel carries a header that uniquely identifies it as data from each ONU 304-N. Unique identification can also be established from timeslot position in the upstream frame. Splitter/combiner 306 combines the separate traffic signals into one signal 404, carrying all of the ONU-specific signal packets. This combined data signal 404 is then sent to OLT 302.

Signal 404 utilizes Time Division Multiplex (TDM) technology, in which transmission time slots are dedicated to the ONUs. The ONU-specific signals are combined using guardbands so that the signals do not interfere with each other once the signals are combined to form signal 404. For example, ONU-1 304A may transmit a signal in the first time slot and ONU-N may transmit a signal in a packet in the Nth non-overlapping time slot.

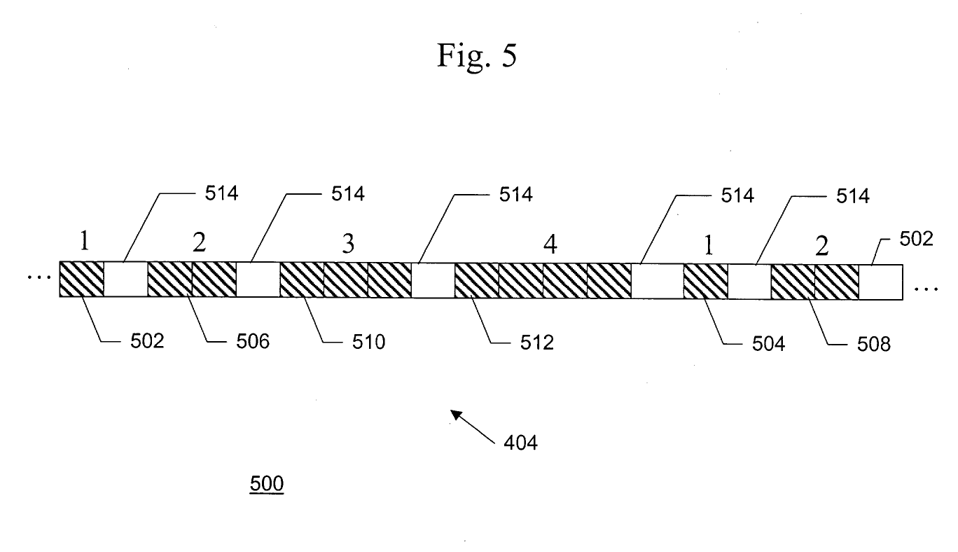

An exemplary format 500 of a combined upstream signal 404 is shown in FIG. 5. Format 500 illustrates the timeslots in combined upstream signal 404 and the placement of ONU-specific signals into combined upstream signal 404. In this example, data signal bursts from four ONUs are shown combined to form signal 404. For example, data signal bursts 502 and 504 are from ONU-1, data signal bursts 506 and 508 are from ONU-2, data signal bursts 510 are from ONU-3, and data signal bursts 512 are from ONU-4. Each data signal occupies one timeslot in signal 404. Guardbands 514 separate data signal bursts from different ONUs. Each guardband occupies one timeslot and is used to ensure that data signal bursts from different ONUs do not overlap. Signals from the same ONU that make up one burst use consecutive timeslots, as there is no danger that they will overlap with each other. In this example, the ONU data signal bursts include 1,2,3, or 4 STS-1 data signals. In addition, the data signals may use a smaller bandwidth modularity, such as including seven VT1.5 channels in a timeslot.

In a preferred embodiment, the downstream implementation of SONET over PON provides one or more standard OC48 channels. Some additions to the standard OC48 are useful, such as use of a spare byte to specify the upstream multiframe format and the use of one or more spare bytes to control fine ranging updates for ONUs assigned to timeslots. This multiframe counter also associates addressed timeslots with section multiframe numbers.

In a preferred embodiment, the upstream implementation of SONET over PON provides a maximum of 32 ONUs, each having a separate upstream channel, assuming 96 timeslots and given that each upstream multiframe includes data, guardbands, and a ranging interval. This implementation would provide 64 residual timeslots for data bursts plus guardbands (96 total timeslots-32 timeslots representing the ranging interval measured in timeslots). Such an implementation would provide a symbol rate of 4.976 Gbps, which is twice the downstream rate. In another preferred embodiment, seven VT1.5 channels may be included in one minimum timeslot, which would allow up to 64 ONUs per PON, with a symbol rate of 2.4883 Gbps. Since the minimum guardband is one timeslot, this would reduce the minimum timeslot size and reduce the guardband overhead.

Preferably, the ONUs and OLTs include double buffering for upstream data on the PON. At the ONU upstream, one buffer of the ONU locally collects the incoming data from the end user, while the second buffer sends the outgoing upstream data over the PON. At the OLT, one buffer collects in incoming upstream data from the PON, while the second buffer sends the data to the SONET network. Double buffering provides a number of advantages:

It allows concatenated timeslots to remain time locked to the OLT.

It allows hitless timeslot re-arrangement under OLT control

It avoids upstream pointer adjustment and simplifies upstream framing at OLT.

Double buffering may be implemented using random access memories or using First-In-First-Out (FIFO) memories. An additional advantage of double buffering is that it allows less costly memories to be used, since a given buffer is only reading or writing at a given time

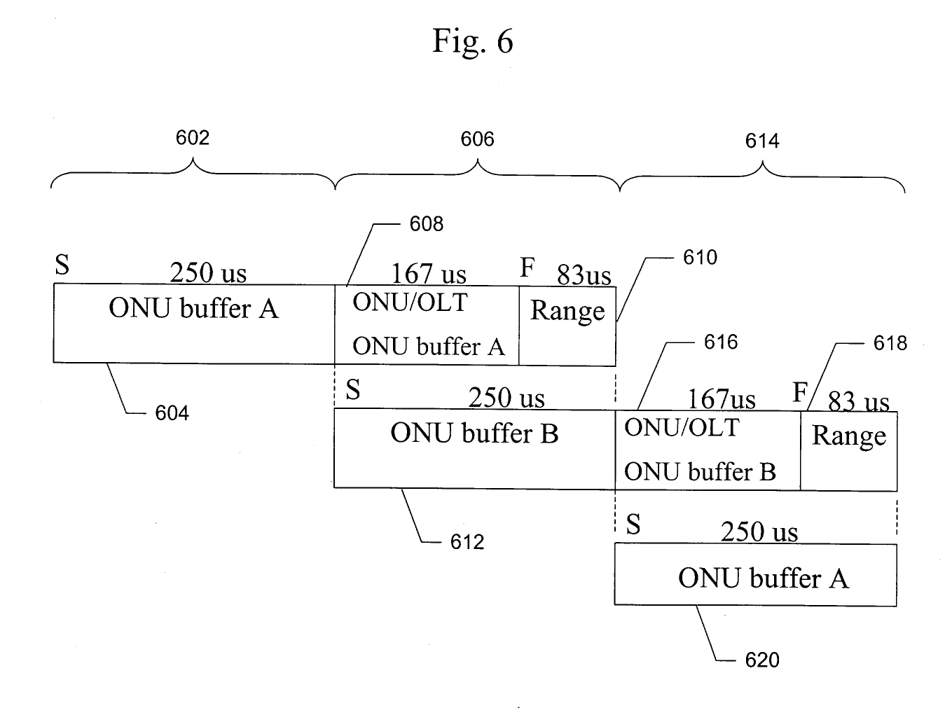

An example of SONET PON upstream delay in the above-described implementation is shown in FIG. 6. In this example, the delay is for transmission of upstream data is 417 μs. In period 602, having an exemplary period of 250 μs, the first ONU buffer, ONU buffer A, is collecting 604 the incoming data from the end user. In period 606, having an exemplary period of 250 μs, the ONUs transmit for a portion 608 of period 606 and the remaining portion 610 of period 606 is reserved for ONU ranging. During period 608, each ONU takes turns transmitting the contents of its buffer. For example, ONU buffer A is transmits the collected data from the end user to the OLT for a portion of period 608, and the other ONUs transmit for the remainder of period 608. During period 610, one ONU may perform ranging, if necessary. In this example, period 608 is 167 μs and period 610 is 83 μs. Also during period 606, the second ONU buffer, ONU buffer B, is collecting 612 the incoming data from the end user. In period 614, having an exemplary period of 250 μs, the ONUs transmit for a portion 616 of period 614 and the remaining portion 618 of period 614 is reserved for ONU ranging. During period 616, each ONU takes turns transmitting the contents of its buffer. For example, ONU buffer B transmits the collected data from the end user to the OLT for a portion of period 616, and the other ONUs transmit for the remainder of period 616. During period 618, one ONU may perform ranging, if necessary. In this example, period 616 is 167 μs and period 618 is 83 μs. Also during period 614, ONU buffer A is collecting 620 the incoming data from the end user.

In a preferred embodiment, each ONU receives a time reference from downstream OLT frames. The ONU locks to this time reference, preferably using a high precision digital phase-locked-loop (PLL) circuit. The upstream frame position is set by ranging (when ONU turns up) to an offset from the downstream frame reference in order to equalize OLT-ONU-OLT round trip delays among the multiple ONUs and so to compensate for differing distances between the OLT and each ONU. For example, if the OLT is provisioned for the closest ONU, the farthest ONU may then be 4 miles further from the OLT. Preferably, the overall precision due to all causes of upstream burst locations should be held to within 1 μs (or less) of the target burst location. The burst precision must be less than ½ of a guardband to avoid ONU-ONU upstream data collisions. Fine ranging correction is periodically sent during traffic handling based on assigned traffic timeslots (1 timeslot correction per 250 μs). The ranging interval uses a contention/backoff algorithm, since several ONUs can turnup at about the same time since ranging has a dedicated time interval. This ensures that there are no traffic hits due to ranging. The number of timeslots dedicated for the length of the ranging interval can be traded off against working timeslots, via provisioning.

The contention/backoff algorithm manages coincidental turnup of multiple ONUs to ensure that they eventually will all turn up. An enhancement would be to provide a “contention busy” indication in the downstream frame to prevent new ONUs from bursting upstream in the ranging interval, if an ONU is currently being ranged. This will reduce the probability of ONU collisions.

Additional enhancements to the system may include using super-multiframe to more efficiently serve sub-STS1 (VT1.5) services and using more than one upstream optical wavelength, such as Coarse Wave-Division Multiplexing (CWDM) to increase bandwidth.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A system for interfacing a Synchronous Optical Network/Synchronous Digital Hierarchy to a Passive Optical Network, the system comprising:
an Optical Line Termination unit operable to:
interface with the Synchronous Optical Network/Synchronous Digital Hierarchy and with the Passive Optical Network,
receive a downstream data signal from the Synchronous Optical Network/Synchronous Digital Hierarchy and transmit the downstream data signal over the Passive Optical Network, as a Synchronous Optical Network/Synchronous Digital Hierarchy data signal, and
receive an upstream Synchronous Optical Network/Synchronous Digital Hierarchy data signal from the Passive Optical Network and transmit the upstream data signal over the Synchronous Optical Network/Synchronous Digital Hierarchy; and
at least one Optical Network Unit operable to:
interface with the Passive Optical Network and with at least one end user,
receive a downstream data signal from the Passive Optical Network and transmit the downstream data signal to the at least one end user, and
receive an upstream data signal from at least one end user and transmit the upstream data signal over the Passive Optical Network.

2. The system of claim 1, wherein the at least one Optical Network Unit is further operable to:
receive a downstream data signal from the Passive Optical Network, as a Synchronous Optical Network/Synchronous Digital Hierarchy data signal including Synchronous Optical Network/Synchronous Digital Hierarchy encapsulation, remove the Synchronous Optical Network/Synchronous Digital Hierarchy encapsulation, and transmit the decapsulated downstream data signal to at least one end user, and
receive an upstream data signal from at least one end user, encapsulate the upstream data signal in Synchronous Optical Network/Synchronous Digital Hierarchy encapsulation, and transmit the encapsulated upstream data signal over the Passive Optical Network.

3. The system of claim 2, wherein the desired end user format comprises at least one of: Ethernet, Internet Protocol multicast, Plain Old Telephone Service, T1, and T3.

4. The system of claim 2, wherein the upstream data signal received from the end user comprises a Synchronous Optical Network Synchronous Payload Envelope.

5. The system of claim 4, wherein the Optical Network Unit is further operable to convert the upstream data signal received from the end user to the optical format by adding a Passive Optical Network Layer to the Synchronous Optical Network Synchronous Payload Envelope.

6. The system of claim 5, wherein the Optical Line Termination is further operable to strip the Passive Optical Network Layer from the upstream data signal received from Optical Network Unit and preserve the Synchronous Optical Network Synchronous Payload Envelope.

7. The system of claim 6, wherein there are a plurality of Optical Network Units.

8. The system of claim 7, wherein the downstream data signal received from the Optical Line Terminations over the Passive Optical Network comprises a plurality of Optical Network Units specific signals.

9. The system of claim 8, further comprising a splitter/combiner operable to divide the downstream data signal comprising the plurality of Optical Network Units specific signals into a plurality of downstream data signals comprising the plurality of Optical Network Units specific signals.

10. The system of claim 9, wherein each Optical Network Unit is further operable to accept an Optical Network Unit specific signal intended for that Optical Network Unit and discard the Optical Network Unit specific signals not intended for that Optical Network Unit.

11. The system of claim 7, wherein each the Optical Network Unit transmits Optical Network Unit specific upstream data signal over the Passive Optical Network.

12. The system of claim 11, further comprising a splitter/combiner operable to combine the Optical Network Unit specific upstream data signals to form a combined upstream data signal comprising the Optical Network Unit specific upstream data signals.

13. The system of claim 12, wherein the Optical Network Unit specific upstream data signals are combined using Time Division Multiplexing, the Time Division Multiplexing controlled by the Optical Network Unit using information from the Optical Line Termination, and the combining performed by passively combining optical signals carrying the upstream data signals.

14. The system of claim 13, wherein the combined upstream data signal comprises Optical Network Unit specific upstream data signals separated from other Optical Network Unit specific upstream data signals by guardbands.

15. The system of claim 14, wherein each Optical Network Unit specific upstream data signal in the combined upstream data signal comprises at least one Time Division Multiplexing time slot.

16. The system of claim 15, wherein each guardband in the combined upstream data signal comprises at least one Time Division Multiplexing time slot.

17. The system of claim 16, wherein each Optical Network Unit comprises a plurality of data buffers, each data buffer operable to receive an upstream data signal from an end user after Synchronous Optical Network/Synchronous Digital Hierarchy encapsulation and to transmit the received upstream data signal to the Optical Line Termination over the Passive Optical Network.

18. The system of claim 17, wherein each data buffer is operable to receive an upstream data signal from an end user while another data buffer is transmitting a received upstream data signal to the Optical Line Termination over the Passive Optical Network and is operable to transmit a received upstream data signal to the Optical Line Termination over the Passive Optical Network while another data buffer is receiving an upstream data signal from an end user.

19. The system of claim 18, wherein each Optical Network Unit is further operable to perform ranging, using information from an Optical Line Termination, to compensate for differing distances between the Optical Line Termination and each Optical Network Unit.
